(19) United States
(12) Patent Application Publication
(10) Pub. No.: US 2017/0103659 A1
(43) Pub. Date: Apr. 13, 2017

(54) METHOD AND SYSTEM FOR IMPLEMENTING AND ENFORCING A NO-FLY ZONE OR PROHIBITIVE ZONE FOR DRONES AND UNMANNED VEHICLES

(71) Applicant: Xin Jin, Waterloo (CA)

(72) Inventor: Xin Jin, Waterloo (CA)

(21) Appl. No.: 14/880,221

(22) Filed: Oct. 10, 2015

(51) Int. Cl. G08G 5/00; G05D 1/00; G05D 1/10; B64C 39/02

(52) U.S. Cl. CPC G08G 5/006; B64C 39/024; G05D 1/0011; G05D 1/101

(57) ABSTRACT

In certain areas, if a drone flies into them, may cause danger to people or facilities within the area. In such areas no-fly zones need to be implemented and enforced. A no-fly zone can be indicated or identified by specially transmitted radio signals in or around the no-fly zone. No-fly zones can also be defined using geo-fence data that is provided to a drone. Once a drone detects itself within a no-fly zone, will disable the control from its original operator or from its pre-programmed flying plan at least in part, and be made harmless.

### CROSS-REFERENCE TO RELATED APPLICATION

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING

Not Applicable.

### BACKGROUND OF THE INVENTION

Field of the Invention

This invention relates generally to safety, in particular, to implementing a no-fly zone or prohibitive zone of drones and unmanned vehicles around sensitive locations to prevent drones and unmanned vehicles causing safety risks.

Description of the Related Art

Drones, also known as unmanned aerial vehicles (UAV), or remotely piloted aircrafts (RPA) become more and more popular. While enjoying many applications that benefit people, drones also caused many incidents and accidents. For example, in March 2014, a remote-controlled helicopter was reported by the crew of a Boeing 777 flying 30 metres from their craft at Vancouver International Airport; in April 2014, video taken from a camera on board a UAV showed it flying close to an airliner as it landed at the same airport; on 21 Jul. 2015, a Lufthansa plane landing at Warsaw Chopin Airport nearly collided with a drone; it was reported that a UAV had flown within 25 metres of an ATR 72 passenger airliner on 30 May 2014 while the aircraft was approaching London Southend Airport; a UAV came about 20 feet of an Airbus A320 landing at Heathrow on 22 Jul. 2014; in March 2013, an Alitalia pilot on final approach to runway 31 right at John F. Kennedy International Airport reported seeing a small UAV near his aircraft; on 22 Mar. 2014, US Airways Flight 4650 nearly collided with a drone while landing at Tallahassee Regional Airport; in October 2013, a UAV collided with Sydney Harbour Bridge; in October and November 2014 unidentified UAVs were seen flying near 13 nuclear power plants in France; in April 2014, a man pleaded guilty of flying a small UAV within 50 m of a submarine testing facility in UK; in January 2015, a DJI Phantom crashed in the grounds of the White House; in July 2015 firefighting aircraft were grounded for 26 minutes in Southern California because of fears of collisions with five UAVs that had been seen in the area—it was the fourth time in as many weeks that drones had hampered firefighters in Southern California; in August 2015 the B.C. Wildfire Service said that an unmanned aerial vehicle flying over the Testalinden Creek and Wilsons Mountain Road wildfires posed a significant risk to personnel, forcing eight fire-fighting helicopters and five planes to land. For public safety, around sensitive locations there is a need for technical solutions to implement no-fly zones which complying commercial drones cannot fly into.

Similar to a UAV, unmanned automobiles, boats, submarines, and robots, as well as unmanned multiple-in-one vehicles (a vehicle that may travel in more than one of the spaces—air, land, overwater and underwater) may become a safety risk as well in sensitive zones such as surrounding areas of nuclear plants, military bases, etc., and also need to block their approaching. In general, there is a need in the art to build a no-fly/no-drive/no-sail-zone/prohibitive zone for unmanned vehicles in which the unmanned vehicles are set to a state that would not pose a risk to the sensitive target(s) in question.

### BRIEF SUMMARY OF THE INVENTION

In one aspect, the invention provides a method of enforcing a no-fly zone for drones, comprising the steps of: determining, by a drone while flying under control of an operator or a pre-programmed flying plan, an entry to a no-fly zone; and performing, by the drone, take-over mode operations; wherein the take-over mode operations ignore the control from the operator or the pre-programmed flying plan at least in part.

In another aspect, at least one embodiment of the invention provides a hardware module, referred to as flying authorization module for being coupled with a drone controller, comprising a data storage device which stores at least one of: permitted fly zone definition data; and no-fly zone definition data. It may further store fly authorization ID; fly authorization valid time; fly authorization expiring time; security digital signature; drone types authorized for use of the hardware module; one or plurality of drone IDs authorized for use of the hardware module; valid time for each of the drone IDs authorized for flying with the hardware module; expiring time for each of the drone IDs authorized for flying with the hardware module; ID of each of the stored permitted fly zones or no-fly zones; effective time for each of the stored permitted fly zones or no-fly zones; valid time for each of the stored permitted fly zones or no-fly zones; expiring time for each of the stored permitted fly zones or no-fly zones; a type indication for each of the no-fly zones; issuing organization for each of the stored permitted fly zones or no-fly zones; owner contact information for each of the stored permitted fly zones or no-fly zones; detour route information around each of the stored no-fly zones; automated de-risk procedure for each of the stored no-fly zones; one or plurality of reference points associated with each of the stored no-fly zones for deriving direction to fly away from the zone; an indicator for availability of a super operator associated with each of the stored no-fly zones; a handover and control protocol for handover by a super operator, associated with each of the stored no-fly zones having a super operator; an expiring time duration for handover by a super operator, associated with each of the stored no-fly zones having a super operator; an indicator for availability of a super arbitrator associated with each of the stored no-fly zones; a hand-over and arbitration protocol for handover by a super arbitrator, associated with each of the stored no-fly zones having a super arbitrator; an expiring time duration for handover by a super arbitrator, associated with each of the stored no-fly zones having a super arbitrator; a special permission to fly into one or a plurality of no-fly zones; a valid time for a special permission to fly into a no-fly zone; a expiring time for a special permission to fly into a no-fly zone; a password to allow activation of a special permission to fly into a no-fly zone; flying limitations to fly into a no-fly zone under a special permission; speed limitations for each of the stored permitted fly zones.

In yet another aspect, the invention provides a method of indicating or identifying a no-fly zone by transmitting special radio signals within or around the no-fly zone, referred to as no-fly-zone indication signals or no-fly-zone identification signals.

Other aspects of the invention will become clear thereafter in the detailed description of the preferred embodiments and the claims.

### BRIEF DESCRIPTION OF THE DRAWINGS

For a better understanding of the invention and to show more clearly how it may be carried into effect, reference will now be made, by way of example only, to the accompanying drawings which show at least one exemplary embodiment of the invention and in which:

FIG. 1 illustrates a fictional and simplified example a no-fly zone for commercial drones that are compliant to no-fly-zone regulation;

FIG. 2 is an example using transmit antenna positions to mark a no-fly-zone boundary.

FIG. 3 illustrates an example using provided reference point to obtain a direction to fly away from a no-fly zone.

FIG. 4 illustrates exemplary steps that a drone controls itself with respect to no-fly zone.

### DETAILED DESCRIPTION OF THE INVENTION

It will be appreciated that in the description herein, numerous specific details are set forth in order to provide a thorough understanding of the invention. However, it will be understood by those of ordinary skill in the art that the invention may be practiced without these specific details. In other instances, well-known methods, procedures and components have not been described in detail so as not to obscure the invention. Furthermore, this description is not to be considered as limiting the scope of the invention, but rather as merely providing a particular preferred working embodiment thereof.

In the specification and claims, the terminology “drone” is used to refer to an unmanned aerial vehicle (UAV), including a remotely piloted aircraft (RPA), or an autonomous aircraft. Furthermore, a “drone” in this specification also broadly refers to any unmanned vehicles, including unmanned automobiles, boats, submarines, and robots, as well as unmanned all-in-one vehicles (a vehicle that is able to travel in more than one of the spaces—air, land, overwater and underwater). Similarly, the terminology of “no-fly zone” also broadly refers to as no-drive zone on land, no-sail zone over and/or under water, generally, a prohibitive zone.

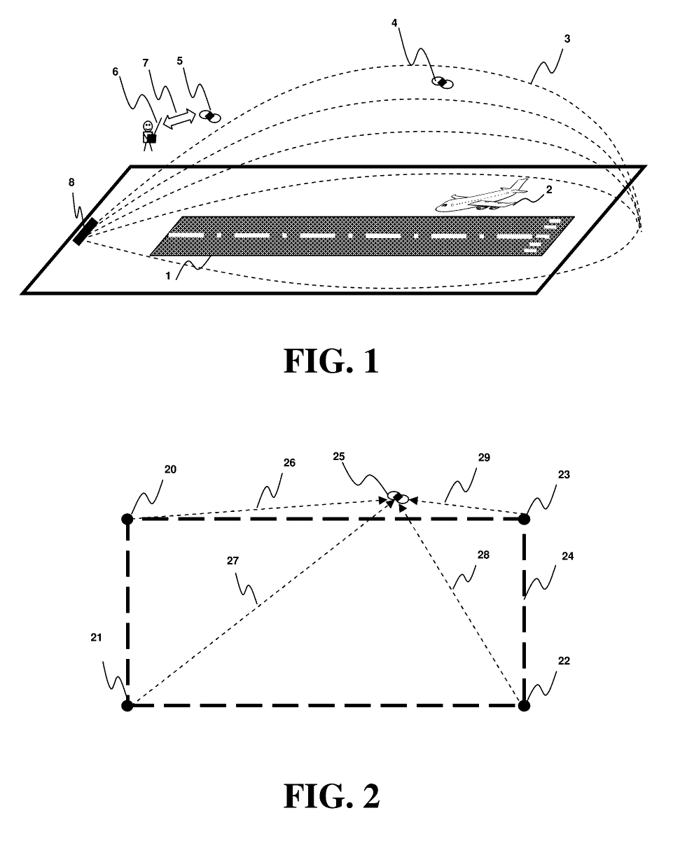

FIG. 1 illustrates a fictional and simplified example a no-fly zone for commercial drones that are compliant to no-fly-zone regulation. In the example, over an airport runway 1 where aircrafts 2 may take off or land, a no-fly zone 3 for drones 4 and 5 is to be implemented. In the example, drone 4 is shown as an autonomous drone which controls itself by its on-board computer or controller without depending on any human operator once lunched; drone 5 is shown as a remotely controlled drone which is controlled by its human operator (or a pilot) 6 through a coupled data link 7 such as a wireless communication link. In a preferred embodiment, the no-fly zone is created and defined by a radiation pattern 3 of a special radio signal, herein referred to as a no-fly-zone indication signal, which is transmitted by one or a plurality of antenna 8 from a transmitter (not shown in the drawing). The radiation pattern 3 is created in such a shape that everywhere within the intended no-fly zone the signal strength is higher than the sensitivity of receivers (not shown in the drawing) installed on-board of the drones 4, 5 that are no-fly-zone regulation compliant. Regulation requirements for commercial drones are enforced such that all drones sold in the market must support an on-board receiver meeting a given sensitivity requirement that continuously or periodically checks whether a no-fly-zone indication signal is present and above a given strength threshold, and whenever such indication signal is detected above the strength threshold, the drone must immediately take procedures to leave the no-fly zone in a safe way no matter what its operator or its on-board computer instructs or originally programmed it to do. The regulation also specifies the signal characterizations of the no-fly-zone indication signal, such as frequency, modulation, and embedded messages.

In another preferred embodiment, the no-fly-zone indication signal further include broadcasting an embedded message that defines the boundary of the no-fly zone using geo-fence parameters such as those based on or in terms of longitude, latitude and altitude; the regulation requires drones that comply to this grade of regulation to support decoding the geo-fence message, and using its on-board global positioning system or regional positioning system receiver (such as GPS/GLONASS/Beidou/Galileo) or other compliant navigation/positioning means to check its location continuously or periodically against the received geo-fence. Once an entry to the no-fly zone is found, the drone must immediately take procedures to leave the no-fly zone in a safe way no matter what its operator or its on-board computer instructs or originally programmed it to do; alternatively, once its position is approaching a no-fly zone, it shall take procedures to avoid entering the no-fly zone no matter what its operator or its on-board computer instructs or originally programmed it to do.

The no-fly-zone indication signal may be radiated by dedicated transmitter and antenna, it may also be radiated by other types of transmitter and antenna, such as a commercial TV and radio stations, radar, instrument landing system, etc, such as through adding a subcarrier, adding an embedded message, or directly define the signal originally for other purpose as one type of no-fly-zone indication signal. For example, the airport instrument landing system signals may be borrowed and defined as one type of no-fly-zone indication signal.

In yet another preferred embodiment, instead of using the radiation pattern of an indication signal to specify the boundary of a no-fly zone, the no-fly zone is identified by a plurality of no-fly-zone identification signals transmitted each from a separate antenna, and using the antenna positions to mark the footprint boundary shape of the no-fly zone. FIG. 2 is an example using transmit antenna positions to mark a no-fly-zone boundary, in which the no-fly zone 24 is a rectangular shape in the 2-dimentional map drawing, the rectangular shape of the no-fly zone is marked by four transmit antennas 20, 21, 22, and 23 placed at the corner points of the no-fly zone. Each of the antenna transmits a distinctive identification signal of the no-fly zone. A drone 25 equipped with an on-board receiver may be able to receive the identification signals from the plurality of antennas. Preferably the identification signals from the plurality of antennas are time synchronized or otherwise time aligned and each signal contains a time mark, such as the beginning of code sequences or a pulse, through such signals, the on-board receiver of drone 25 is able to measure the delay or delay difference of the radio propagation from each of the antennas to the drome, over the links 26, 27, 28 and 29. This would allow the on-board receiver to calculate the drone position relative to the antennas, and thus obtaining position relation with respect to the boundary of the no-fly zone. Preferably each of the signals from the antennas also broadcast additional information such as the position of each antenna in longitude, latitude, and altitude. It may also include a message that defines the zone using geo-fence parameters. Alternatively, the plurality of antennas do not use their positions to mark the boundary of the no-flay zone but are placed closely around the footprint of the no-fly zone (not shown in the drawing), and relying the identification signals and a message to enable an on-board receiver to calculate the drone position through measured propagation delays and check against the boundary definition broadcasted by the message. Although the antenna positions are not exactly marking the no-fly zone boundary, since their positions are known, the drone would still able to calculate its position relative to the zone, based on the zone definition geo-fence parameters broadcasted in message.

In an alternative embodiment, instead of using a receiver on-board of a drone to receive the no-fly-zone definition, the no-fly-zone definition is transferred to the drone through other means, including through a hardware module, referred to herein as flying authorization module. A regulation compliant drone is required to detect the presence of a flying authorization module in order to fly, i.e., without a valid flying authorization module a regulation compliant drone shall not be able to fly. The flying authorization module may be physically provided by a regulation authority, or its contents be provided by a regulation authority. Either way, digital signature or other security means may be used to guarantee that the contents are truly from the regulation authority. The flying authorization module may contain an authorization identification of the drone user, so that no matter which physical drone is flying, as long as the particular flying authorization identification is used, its identification owner takes the legal responsibility. The flying authorization module may further contain permitted fly-zone definition data or otherwise contain no-fly-zone definition data such as in the form of geo-fences. During flying, a regulation compliant drone shall, through its navigation means such as GPS, check its current position against permitted fly-zone or no-fly-zone definitions stored in its flying authorization module, and once its position is within a no-fly zone, it shall immediately take procedures to leave the no-fly zone in a safe way no matter what its operator or its on-board computer instructs or originally programmed it to do; alternatively, once its position is approaching a no-fly zone, it shall take procedures to avoid entering the no-fly zone no matter what its operator or its on-board computer instructs or originally programmed it to do. The flying authorization identification as well as the permitted fly-zone or no-fly-zone definition data each may be associated with an expiring date and time, a regulation compliant drone shall check the expiring status and once found expired, it shall not able to fly with it. The permitted fly-zone or no-fly-zone definition data including their expiring time contained in a flying authorization module may be renewed or updated through network or storage media from regulation authorities, and the expiring time of the flying authorization identification may also be renewed through network or storage media from regulation authorities. The flying authorization module may be a plug-in module that can be replaced in field by drone user, such as through a socket installed on a drone, or may be built-in on a drone during manufacturing that cannot be replaced without engineering work.

In another alternative embodiment, the permitted fly-zone definition data or no-fly-zone definition data such as in the form of geo-fences are stored in memory or data storage device associated with the on-board controller of the drone without a physically separable hardware module. The fly-zone or no-fly-zone definition data are either pre-stored in the controller during manufacturing, or downloaded and/or updated through network or data media onto the controller after manufacturing. The definition data are either from regulation authority or indirectly from the manufacturer that is authorized by the regulation authority. The on-board controller of a drone may also be further loaded with an identification that uniquely identifies the authorized user. All the functions of the fly-zone or no-fly-zone definition data, including their expiring time if available, as well as the identification, including its expiring time if available, are identical to what are described hereinabove, except without a separate hardware module.

In general several types of no-fly zones are needed. One type is long-term no-fly zones, such as those set up around nuclear plants, which are set up all time over fixed locations; another type of no-fly zones have fixed location but have fixed on-off schedule, such as one that is set up over a single runway of a small airport that is closed every night; the third type is ad-hoc and mostly short-term no-fly zones such as those set up at sites of wildfires to allow firefighting aircrafts to operate. The embodiment hereinabove that uses a no-fly-zone indication signal or identification signal to define is suitable for enforcing all these types of no-fly zones since the indication/identification signal may change over time, a drone supporting such indication/identification signals is able to receive the change right away. In the embodiments hereinabove that use a flying authorization module or built-in storage to store the definition data of no-fly zones, in order to fully support ad-hoc no-fly zones, the drone must include a receiver that supports receiving and updating the definitions of ad-hoc no-fly zones wirelessly. Preferably a drone supports both pre-downloaded definitions as well as instantaneous indication and identification or real-time updating.

The no-fly-zone definition, no matter it is broadcasted as definition messages, pre-stored or downloaded as definition data, may further include such attributes as effective time duration or time of day and week, issuing organization and owner contact information; in addition, it may be desirable to further include detour route information to fly around the zone, especially when multiple no-fly zones are close to each other. A no-fly-zone issuer (i.e., owner) is responsible to report the setup of the zone to the regulating authority, and update the no-fly-zone database at the authority for drone users to download. A drone shall record and report to the regulating authority the no-fly zones that it had encountered once the drone has a chance to connect to the network (e.g., after retrieval) so that illegal no-fly zones can be found and corrected. Drones have wireless transmitters may also report it wirelessly.

For drones with pre-programmed flying plan, it is desirable while programming the plan or at least before the drone is lunched and the flying plan starts to run, the flying plan programming tool, the flying plan loading tool, or the drone controller would provide warnings to the operator if the plan has violated any no-fly-zone requirements.

When a regulation compliant drone detects itself within a no-fly zone, the drone shall immediately enter a special mode, herein referred to as “take-over mode”, in which the original operator no longer has control to the drone (at least in part), and the drone is either controlled by an automated de-risk procedure or by a “super operator” who represents the owner of the no-fly zone. In one preferred embodiment the automated de-risk procedure is broadcasted through the no-fly-zone indication/identification signal as a message, and is decoded by an on-board wireless receiver of the drone. In another embodiment, the automated de-risk procedure is pre-stored in association with the zone definition data, e.g., pre-stored in a flying authorization module, or pre-stored with the built-in controller of the drone. The pre-stored automated de-risk procedure may be on a zone-by-zone basis, i.e., different zones may be stored with different instructions, or otherwise, be stored uniformly identical for all zones. The de-risk procedure may instruct the drone to perform at least one of the operations: 1) stop the engine(s) and crash the drone at current location—if supported, the drone may release a parachute and/or an air bag for safer touching to the ground; 2) attempt to land at current location as soft as possible; 3) fly away from a reference point as provided in terms of latitude and longitude; 4) hover at current location and attitude if supported, and wait for being captured by a capturing net or otherwise being made harmless. Among these options, option 1) usually is used in a guard zone of a protected core zone, where crashing would not cause danger to the protected targets; option 2) implements a relatively soft landing for purpose to reduce risks of damages to facilities on ground, and usually not for avoiding damages to the drone; option 3) can be used for drones that are equipped with navigation means such as GPS, so that the drone is able to find the direction away from the provided reference point; if option 3 is given in the procedure but a reference point data is not provided, a default reference point can be used, which is the geometry center of the footprint shape of the entire no-fly zone; option 4 is for drones that support hovering, the no-fly zone owner may dispatch a manned or unmanned craft to retrieve the drone using a capturing net, or use other means to make the drone harmless. The de-risk procedure may further include an indication whether to allow the drone to resume normal operation mode after leaving the no-fly-zone.

Preferably, the no-fly zones may be divided into multiple tiers, for example, in addition to the core area to enforce highest degree of protection, the core zone may be surrounded by zones of lower degree of protections, such as guard zone and warning zone, etc. Associated with each zone or subzone, a type indication data may be provided together with the zone definition data, to indicate that it is a core zone, guard zone, or a warning zone, etc. In some zones, such as a warning zone, the de-risk procedure can be less tough than higher degree of zones, for example, it may just provide a warning to the operator and let the operator take actions to avoid the no-fly zone. The warning may be triggered by detection of its location against pre-stored or received geo-fence definition of the zone, and its contents retrieved from the de-risk procedure pre-stored or broadcasted in association with the zone definition. Once the warning message is triggered and retrieved, the message would be indicated through a user interface to the operator, such as in the form of one or multiple types of visible and/or audible indication signals. In some zones, the de-risk procedure may still allow the user to retrieve the drone after completed the de-risk procedure, however, in some higher degree zones, the drone may have to be confiscated after completing the de-risk procedure, depending on the de-risk procedure associated with the zone or sub-zone definition.

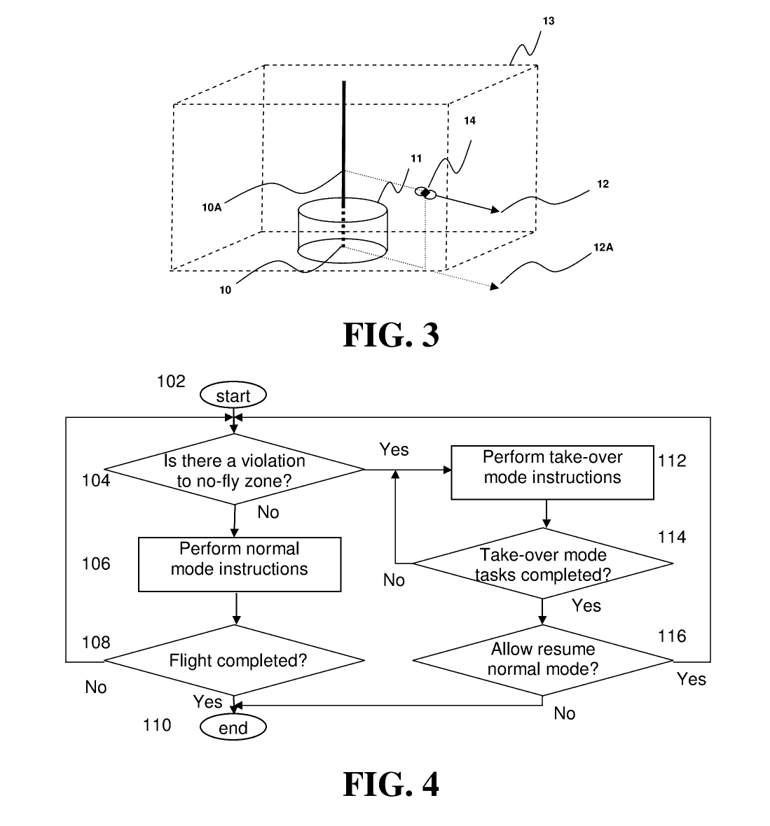

FIG. 3 illustrates an example using provided reference point to obtain direction to fly away from a no-fly zone, i.e., the option 3 of the automated de-risk procedure described hereinabove. In the example, a no-fly zone 13 is set up to protect an oil tank 11. A drone 14 somehow entered the no-fly zone 13, and thus its operation entered into the take-over mode. Associated with the no-fly zone definition data that the drone 14 obtained, is the automated de-risk procedure, which instructs the drone 14 to fly away from a reference point 10, as specified in terms latitude and longitude provided together with the no-fly zone definition data. Since no altitude is specified for the reference point 10, it means the reference point is a 2D point where altitude does not matter. The drone then is able to find its escape direction 12 by its own current location 14 (obtained by its on-board, off-board or hybrid navigation/positioning means, such as GPS), and the corresponding reference point 10A at the same altitude of the drone. The escape direction is along the extension between the two points 10A and 14, as shown in drawing as 12. In the drawing, it also shows 12A the ground projection of the escape direction 12. In the example, the no-fly zone definition data is conveyed to the drone controller either through a message broadcasted wirelessly or pre-loaded into the controller of the drone, such as through a flying authorization module or internet connection.

When a regulation compliant drone detects itself within a no-fly zone, and enters a take-over mode, the drone should support accepting remote control instructions from a super operator through an on-board wireless receiver, and support standardized handover and control protocols for the super operator control, if the drone supports such grade of regulation. Preferably such drones should also be equipped with a wireless transmitter, when the no-fly-zone indication/identification signal or the no-fly-zone definition message indicates that the no-fly zone has a super operator on duty, the on-board controller should automatically send a notification message through the transmitter to indicate that the drone is ready to be taken over by the super operator, if desired by the super operator. The super operator thus may take over the control of the drone, and then, for example, control the drone to land or crash itself at desired safe location, or fly away along a safe route. The on-board controller and transmitter should acknowledge to the super operator for each of the control instructions received and performed. Under the discretion of the super operator, the drone may be granted its normal operation mode again and get control back to the original operator after leaving the no-fly zone. If the drone is not taken over by the super operator in response to the notification message, after a pre-determined period of time, the drone shall execute the automated de-risk procedures received or pre-stored. A timer can be used to control the execution of this fall-back action. If the super operator does take over after the automated de-risk procedures have started, the procedures shall stop immediately and gives the control to the super operator.

In an alternative embodiment, when entering a take-over mode, the drone is flying under control by a combination of sources but under a final arbitration of a super arbitrator. For example, the original operator may continue to send fly instructions if the drone was remotely controlled, the automated de-risk procedures also is sending pre-determined fly instructions, and eventually which of these instructions takes effect is determined by the super arbitrator. The arbitrator may accept the original operator's fly instruction if it does not conflict with the arbitrator's intention. Otherwise, the arbitrator may deny the original operator's instruction, the control then may be given to the pre-determined automated de-risk procedure, or be given to the super operator. The super arbitrator and the super operator may also be the same person or same group of persons.

While drones are banned to fly over a no-fly zone, some drones may be a part of the mission and given exceptions to allow them fly over. For example, when most drones are banned over firefighting site of wildfire, some drones might be on their firefighting mission. In order to allow authorized drones to fly into the no-fly zones, special electronic pass may be given to the drones. The electronic pass may be implemented by a special flying authorization module attached to the drone in question that is coded to ignore the specific zone, or by a standalone “permit module” attached thereto. It may also be implemented by broadcasting a message in the no-fly-zone indication/identification signal to identity certain drone ID as permitted. Alternatively, the special permission can be given as a pass-code provided by the regulation authority or by the no-fly-zone owner that can be input into the drone controller so that the drone controller can verify and accept the permission. A no-fly zone can also be partitioned into multiple grades of sub-zones to selectively give permissions to certain drones.

FIG. 4 illustrates exemplary steps that a drone controls itself with respect to no-fly zone. The operation starts with step 102, and a regulation complying drone controller shall verify at step 104 whether the current location has violated any no-fly zones, using at least one of the following means: if supporting receiving no-fly-zone indication signals, check if such indication signal is present; if supporting receiving no-fly-zone definition message broadcasted by radio signal, or if having pre-stored or pre-loaded no-fly-zone definition data such as in terms of geo-fence data, and supporting navigation technology such as being equipped with GPS/GLONASS/Beidou/Galileo receiver, or supporting calculating location based on the no-fly-zone identification signals, check whether the current drone location is within any no-fly-zone geo-fences. If the result is negative, proceed to step 106 to perform normal mode instructions, received either from a remote operator through wireless link, or preprogrammed in the on-board controller. Next, at step 108 checking if the flight have completed, and depend on the result, either stop at step 110, or repeat step 104. If the result of step 104 is found to be positive, i.e., the drone has entered into a no-fly zone, then the drone will immediately enter a “take-over” mode of operation at step 112, in this mode, the drone ignores its original operator or originally programmed flying plan, its control is taken over either by automated de-risk procedure, or taken over by a super operator, or arbitrated by a super arbitrator, who represent the owner of the no-fly zone, and perform actions needed to make this drone harmless to the target(s) protected by the no-fly zone. The automated de-risk procedure is either received from radio through a message, or is a data associated with the zone definition data. In this take-over mode, if a super operator is on duty serving this zone, protocols to handover to the super operator's control shall be followed in the take-over mode operation, as described hereinabove. Step 114 checks whether all tasks of de-risk procedure has completed, or the super operator/arbitrator has finished all that need to do and gave “completed” indication, depending on which is in charge of the control. If not completed yet, will continue the take-over mode operation 112; if completed, step 116 finds out whether the super operator/arbitrator or the automated de-risk procedure, whichever in charge, allows the drone to go back to its normal mode, if allows, proceeds to step 104, if does not allow, the drone will continue to ignore instructions from original operator or the pre-stored flying plan and the procedure finishes at step 110. In some cases the super operator/arbitrator or the automated de-risk procedure would not allow a drone to go back to its normal mode and the drone will remain in disabled condition.

Certain terms are used to refer to particular components. As one skilled in the art will appreciate, people may refer to a component by different names. It is not intended to distinguish between components that differ in name but not in function.

The terms “including” and “comprising” are used in an open-ended fashion, and thus should be interpreted to mean “including, but not limited to”. The terms “example” and “exemplary” are used simply to identify instances for illustrative purposes and should not be interpreted as limiting the scope of the invention to the stated instances.

Also, the term “couple” in any form is intended to mean either a direct or indirect connection through other devices and connections.

It should be understood that various modifications can be made to the embodiments described and illustrated herein, without departing from the invention, the scope of which is defined in the appended claims.

I claim:

1. A method of enforcing a no-fly zone for drones, comprising the steps of:
determining, by a drone while flying under control of an operator or a pre-programmed flying plan, an entry to a no-fly zone; and
performing, by the drone, take-over mode operations;
wherein the take-over mode operations ignore the control from the operator or the pre-programmed flying plan at least in part.

2. The method of claim 1, wherein the determining an entry to a no-fly zone comprises at least one of
receiving, by an on-board wireless receiver, a no-fly-zone indication signal;
calculating, by an on-board wireless receiver, the drone position relative to the no-fly zone based on a plurality of no-fly-zone identification signals received; and
detecting, by an on-board controller, that a current location of said drone is within a no-fly zone.

3. The method of claim 2, wherein said detecting a current location within a no-fly zone includes checking the current location against a no-fly-zone definition data.

4. The method of claim 3, wherein the no-fly-zone definition data is represented by geo-fence parameters.

5. The method of claim 3, wherein the no-fly-zone definition data is obtained by the drone through at least one of:
receiving, by an on-board wireless receiver, a message that contains the definition data;
reading from a hardware module coupled with the drone that pre-stores the definition data; and
downloading the definition data onto a storage device on-board of the drone through a network connection.

6. The method of claim 3, wherein the current location is calculated based on parameters from at least one of:
an on-board global or regional positioning satellite system receiver;
at least one on-board gyro sensor;
at least one on-board accelerating sensor;
at least one on-board barometer or pressure or pressure difference sensors for obtaining at least one of altitude, airspeed, air velocity, angular airspeed, angular air velocity;
a means obtaining wind velocity around said drone;
at least one of on-board earth magnetic field sensor;
at least one on-board wireless receiver to be able to determine at least one of angle, time, time difference of received wireless signals;
an on-board transmitter to be able to transmit a signal for measuring propagation parameters of said signal by at least one off-board receiver;
at least one on-board image or light sensors to detect on-sky position of at least one of sun, moon and stars;
a means to provide time; and
a radar.

7. The method of claim 1, wherein said take-over mode operations include at least one of:
the drone is flying according to a de-risk procedure;
the drone is flying under the control of a super operator other than the original operator; and
the drone is flying under control by a combination of sources but under a final arbitration of a super arbitrator.

8. The method of claim 7, wherein said de-risk procedure includes at least one of stopping an engine;
attempting a soft landing;
flying away;
hovering at current position; and
warning.

9. The method of claim 7, wherein said de-risk procedure is obtained by the drone through at least one of
over-the-air signals received by an on-board wireless receiver;
a hardware module coupled with the drone controller that pre-stores the procedure; and
downloading onto an on-board storage device coupled with the drone controller.

10. The method of claim 7, wherein the drone is flying under the control of a super operator further includes an hand-over and control protocol comprising:
detecting that the no-fly zone has a super operator on duty;
sending a notification message indicating that the drone is ready to be taken over by the super operator;
performing default flying procedure while waiting for the super operator's response;
if within a predetermined timer period, the super operator did not respond:
starting performing automated de-risk procedures; and
if, at any time, the super operator responded:
stopping performing current operation instructions from other than the super operator;
receiving and acknowledging reception of each of control instructions from the super operator; and
performing and acknowledging completion of each of control instructions from the super operator.

11. The method of claim 7, wherein the drone is flying under control by a combination of sources but under a final arbitration of a super arbitrator, further includes an hand-over and arbitration protocol comprising:
detecting that the no-fly zone has a super arbitration on duty;
sending a notification message indicating that the drone control is ready to be arbitrated by the super arbitrator;
performing default flying procedure while waiting for super arbitrator's response;
if, within a predetermined timer period, the super arbitrator did not respond:
starting performing automated de-risk procedures; and
if, at any time after the sending step, the super arbitrator responded:
forwarding control signals from all sources to the super arbitrator;
receiving and acknowledging reception of each of arbitration instructions from the super arbitrator; and
performing each of fly instructions selected by the super arbitrator.

12. The method of claim 8, wherein the procedure of flying away is away from a reference point, and the reference point position data is obtained from at least one of:
over-the-air signal message, received by an on-board wireless receiver;
a hardware module coupled with the drone controller that pre-stores the reference point position data;
downloading onto a storage device coupled with the drone controller; and
calculating based on a footprint shape of the no-fly zone.

13. The method of claim 8, wherein performing at least one of the procedures of stopping an engine and attempting a soft landing further includes releasing at least one of a parachute and an air bag by the drone.

14. A hardware module for being coupled with a drone controller comprising a data storage device which stores at least one of:
permitted fly zone definition data; and
no-fly zone definition data.

15. The hardware module of claim 14, wherein the at least one of permitted fly zone definition data and no-fly zone definition data is represented by geo-fence parameters.

16. The hardware module of claim 14, wherein the data storage device further stores at least one of:
fly authorization ID;
fly authorization valid time;
fly authorization expiring time;
security digital signature;
drone types authorized for use of the hardware module;
at least one drone IDs authorized for use of the hardware module;
valid time for each of the drone IDs authorized for flying with the hardware module;
expiring time for each of the drone IDs authorized for flying with the hardware module;
ID of each of the stored at least one of permitted fly zones and no-fly zones;
effective time for each of the stored at least one of permitted fly zones and no-fly zones;
valid time for each of the stored at least one of permitted fly zones and no-fly zones;
expiring time for each of the stored at least one of permitted fly zones and no-fly zones;
a type indication for each of the no-fly zones;
issuing organization for each of the stored at least one of permitted fly zones and no-fly zones;
owner contact information for each of the stored at least one of permitted fly zones and no-fly zones;
detour route information around each of the stored no-fly zones;
automated de-risk procedure for each of the stored no-fly zones;
at least one reference point associated with each of the stored no-fly zones for deriving direction to fly away from the zone;
an indicator for availability of a super operator associated with each of the stored no-fly zones;
a handover and control protocol for handover by a super operator, associated with each of the stored no-fly zones having a super operator;
an expiring time duration for handover by a super operator, associated with each of the stored no-fly zones having a super operator;
an indicator for availability of a super arbitrator associated with each of the stored no-fly zones;
a hand-over and arbitration protocol for handover by a super arbitrator, associated with each of the stored no-fly zones having a super arbitrator;
an expiring time duration for handover by a super arbitrator, associated with each of the stored no-fly zones having a super arbitrator;
a special permission to fly into at least one of no-fly zone;
a valid time for a special permission to fly into a no-fly zone;
a expiring time for a special permission to fly into a no-fly zone;
a password to allow activation of a special permission to fly into a no-fly zone;
flying limitations to fly into a no-fly zone under a special permission;
speed limitations for each of the stored permitted fly zones.

17. An unmanned vehicle, comprising:
a controller;
a storage medium;
computer instructions stored in the storage medium; and
the computer instructions being executable by the controller for:
detecting whether or not the unmanned vehicle is within at least one of a no-fly zone, no-drive zone, no-sail zone and a prohibitive zone; and
if detected positive, causing the unmanned vehicle to enter a special mode of operation that disables the control from at least one of an original operator and an originally programmed traveling plan at least in part.

18. The unmanned vehicle of claim 17 further includes:
at least one wireless receiver that is coupled with the controller, for receiving at least one of no-fly-zone indication signals, no-fly-zone identification signals, no-drive-zone indication signals, no-drive-zone identification signals, no-sail-zone indication signals, no-sail-zone identification signals, prohibitive zone indication signals, prohibitive zone identification signals, global positioning satellite signals, regional positioning satellite signals; and
whereby the controller is operable to determine whether or not the unmanned vehicle is within at least one of a no-fly zone, no-drive zone, no-sail zone and a prohibitive zone based at least in part on the at least one of signals, messages and parameters that the wireless receiver provides to the controller.

19. The unmanned vehicle of claim 17 further includes:
a hardware module coupled to the controller, for providing at least geo-fence data that defines at least one of no-fly zones, no-drive zones, no-sail zones and a prohibitive zones;
a navigation subsystems, coupled to the controller, for determining the position of the unmanned vehicle; and
whereby the controller is operable to detect whether the unmanned vehicle is within at least one of a no-fly zone, no-drive zone, no-sail zone and a prohibitive zone based at least in part on the unmanned vehicle position reported by the navigation subsystem and the geo-fence data provided by the hardware module.

20. The unmanned vehicle of claim 17 further includes:
a wireless receiver coupled with the controller, for receiving signals from least one of a super operator and a super arbitrator during the special mode of operation; and
a wireless transmitter coupled with the controller, for transmitting signals to at least one of a super operator and a super arbitrator during the special mode of operation.
